(19) United States
(12) Patent Application Publication
(10) Pub. No.: US 2008/0081315 A1
(43) Pub. Date: Apr. 3, 2008

(54) Dr. Seoung Ho Lee's augmentation plates for stabilizing dental implant fixtures

(76) Inventors: Samuel S. Kim, Richardson, TX (US); Seoung Ho Lee, Seoul (KR)

Correspondence Address: Ms. Connie K. Kim, 4629 Cape Charles Dr., Plano, TX, 75024, US

(21) Appl. No.: 11/527,950

(22) Filed: Sep. 28, 2006

(51) Int. Cl. A61C 8/00

(52) U.S. Cl. 433/173

(57) ABSTRACT

This invention is a titanium plate developed for the temporary support of dental implant fixtures during alveolar ridge bone regeneration. When the alveolar ridge bone where the implant fixture is to be applied is very weak or damaged, this invention enables implant operation on the weak bone by temporarily supporting the implant fixture during the bone recovery time. This invention is characterized by a flat plane shape, a body section with one or more pass-through holes formed along its length, multiple arms extending from each side of the body section with a pass-through hole at the terminal of each arm for fixture to the alveolar ridge bone or facial bone with a micro screw. The body section is designed to be placed between the cover screw that passes through the hole and the implant fixture to hold the implant fixture firmly in place. The plate provides space for bone regeneration and can be readily removed after the completion of the implant-bone integration.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND

This invention is for the augmentation plate for the temporary support of the dental implant fixtures for the alveolar ridge bone regeneration. When the alveolar ridge bone where the implant fixture is to be applied is very weak or damaged, this invention, this invention, a titanium plate, enables implant operation on the qualitatively and quantitatively weak alveolar ridge bone by temporarily augmenting the implant fixture during the bone recovery time. In brief, the plate in this invention secures the space for bone regeneration to promote successful osseous-integration between the implant fixture and the alveolar ridge bone, allows the effective increase in bone volume, and can be removed after the regenerated bone and implant fixture are fused firmly.

Dental implant technology is composed of the process of external installation of the implant fixture on the bone accomplishing the osseous-integration between the implant fixture and the bone over time then connecting a prostheses to the implant fixture. The success of such implant technique depends on the successful osseous-integration between the implant fixture and the bone. Therefore in order to accomplish successful integration between an implant fixture and the bone, there should not be any movement of the implant fixture during the implant time and for this the implant fixture must be placed within a qualitatively and quantitatively healthy bone.

Unfortunately, since, many patients have bones that are limited in quality and quantity, various bone increase techniques are being tried in order to recover the bones. One of the bone increase techniques is supplementing a block bone to the existing bone to increase the bone volume and improve its quality in order to recover and support the implant fixture.

In reference, a patent on dental implant method to fix the bone using screws titled, Dental Implant and Method of Implantation, U.S. Pat. No. 5,052,930, was published on Oct. 1, 1991. FIG. 10 shows one of the drawings of what is called the Lodde implant. Referring to FIG. 10, the Lodde implant consists of a central hub with a vertical post (80) and branches (82) extending in radial direction from the hub with a hole (84) at the center of each branch terminal.

The above-mentioned Lodde Implant uses screws (86) to fix the branches (82) to the bone therefore it is difficult to place the implant in a patient with severely weak bones. Also, the size of the implant itself is large for a permanent fixture within the mouth and its complex structure makes it difficult for a realistic application. In addition, the patient feels severe foreign sensation after installation and often experiences unwanted intra oral exposure. Particularly in the case of food intake after sealing the oral cutaneous membrane, the occlusal force applied on the implant results in a very high probability of infection due to the branches moving and rubbing against the oral cutaneous membrane.

Bone regeneration techniques are currently being carried out in order to firmly place the implants to the bones, but there are patients who have such weak bones that bone regeneration cannot be accomplished, making it difficult for these implant technique to be carried out. This invention is the result of a research to firmly place implants which do not have branches to be fixed to the bone like the previous Lodde Implant for patients who have fragile bones.

### SUMMARY

This invention is for the augmentation plate for the temporary support of the dental implant fixtures for the alveolar ridge bone regeneration. When the alveolar ridge bone where the implant fixture is to be applied is very weak or damaged, this invention, a titanium plate, enables implant operation on the qualitatively and quantitatively weak alveolar ridge bone by temporarily augmenting the implant fixture during the bone recovery time.

The dental implant fixture augmentation plate in this invention is characterized by a flat plane shape, a body section with one or more pass-through holes formed along its length, multiple arms extending from each sides of the body section with a pass-through holes at the terminal of each arm for fixture of the alveolar ridge bone or facial bone with a micro screw, and the body section located between the cover screw that passes through the hole and the implant fixture in order to firmly hold the implant fixture.

The purpose of this invention is to provide a plate which temporarily augments an implant fixture in place of the bone to allow bone regeneration and implant placement simultaneously to severely damaged and weakened bones. Such plate provides space for regeneration of the bone from severe resorption and can be readily removed after increase in bone volume and completion of implant-bone integration. The plate provides space for bone regeneration for bones with serious resorption problem and can be readily removed after the completion of the implant-bone integration.

Therefore, the invention purpose of the plate in this invention is different from the previously mentioned Lodde Implant. The Lodde invention is the implant itself that is permanently fixed in the oral cavity. This invention, on the other hand, is a plate that provides simultaneous bone regeneration and traditional implant operation to patients who have weak bones by providing the space for bone generation while temporarily supporting the implant fixture. In addition, the plate from this invention can be removed after the implant is firmly fixed to the strengthened bone thereby preventing inflammation caused by rubbing, unwanted exposure, and severe foreign sensation inside the mouth.

### DESCRIPTION OF THE DRAWINGS

Drawings of the invention have been chosen for purposes of illustration and description, and are shown in the accompanying figures, wherein:

FIG. 1 is a detailed drawing of a first example of the plate in this invention.

FIG. 2 is a detailed drawing of a first example of the plate in this invention with a different number of arms extending from the body.

FIG. 3 is a detailed drawing of a second example of the plate in this invention

FIG. 4 is a detailed drawing of a third example of the plate in this invention.

FIG. 5 is a detailed drawing of a fourth example of the plate in this invention.

FIG. 6 is a detailed drawing of a fifth example of the plate in this invention.

FIG. 7 is a detailed drawing of a sixth example of the plate in this invention.

FIG. 8 is a detailed drawing of a seventh example of the plate in this invention.

FIGS. 9a through 9i are drawings which show the step by step installation of the plate in this invention.

FIG. 10 is a drawing of the dental implant of a previous technology.

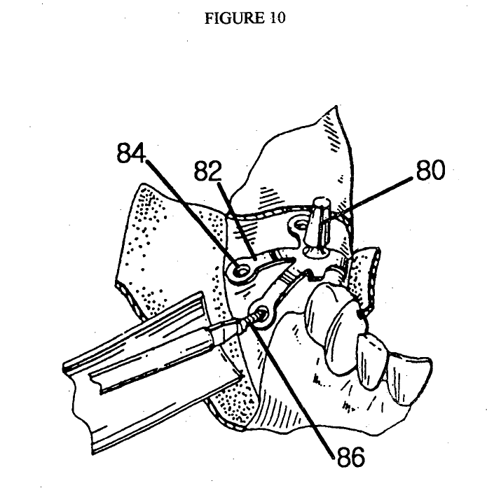

Throughout the drawings, similar elements are referred to by similar letters.

### DESCRIPTION OF THE INVENTION

The dental implant fixture augmentation plate in this invention is characterized by a flat plane shape, a body section with one or more pass-through holes formed along its length, multiple arms extending from each sides of the body section with a pass-through hole at the terminal of each arm for fixture of the alveolar ridge bone or facial bone with a micro screw, and the body section located between the cover screw that passes through the hole and the implant fixture in order to hold the implant fixture.

The plate is made out of Titanium and is fixed to the weak bones by micro screws and is combined with the implant fixture by the cover screws. The plate ensures the stability of the implant fixture and allows good support between the implant fixture and the bone. Moreover, it can be placed exactly where the implant fixture is needed by the bone. It is resistant to bone resorption and is advantageous to maintenance and plaque management.

Since the plate can also be cut as necessary and fixed to the bone-surface using micro screws, the implant operation can be performed in patients who have severely damaged weak bones. Also, the place can secure the space for bone regeneration therefore both the bone transplant and implant operation can be performed simultaneous so the number of operations and the overall implant operation time can be reduced significantly. Once the bone integration is complete, the implant fixture can be removed from the mouth thereby preventing any inflammation in the oral membrane and improving esthetics.

The plate from this invention has a special feature that at least one of the pass-through holes along the center of the body section is oval shape with a longer length. The oval shaped pass-through hole can temporarily intervene the distance between the implants to place the implant fixture in a desired spot and is adjustable before and after the implants.

Another special feature of this invention is that at least one of the pass-through holes in the body section is offset by a fixed distance. The pass-through hole of the body section coincides with the posterior teeth arrangement of the natural teeth between the premolar area and molar area therefore the implant fixture can be placed in the exact location. Here, the offset distance of the pass-through hole in the body section should be less than 2 mm considering the adult anatomical oral structure. Therefore the longer extended arm from one side of the body section extends to the buccal side of the face and the shorter extended arm section from the opposite side can extend to the palatal side allowing exact fixture location corresponding to the anatomical structure.

Another special feature of the plate from this invention is that the center arm extending from one side of the body section is longer than the other arms. The longer arm in the center allows the plate to be fixed to the zygomatic process of the maxillary bone using micro screws therefore the plate can be even more firmly secured.

The plate from this invention serves the purpose of fixing the implant fixture to the damaged bone for a set time and is characterized by a flat plane shape, a body section with one or more pass-through holes formed along its length, multiple arms extending from each sides of the body section with a pass-through hole at the terminal of each arm for fixture of the alveolar ridge bone or facial bone with a micro screw, and the body section located between the cover screw that passes through the hole and the implant fixture in order to hold the implant fixture. The plate enables the implant to be fixed to the bone-surface even in the case of patients with severely damaged bone, and the implant fixture can be place in the correct location on the bone.

Below is the description of the plate for fixing the implant for a set time to a weakened bone in reference to the included figures.

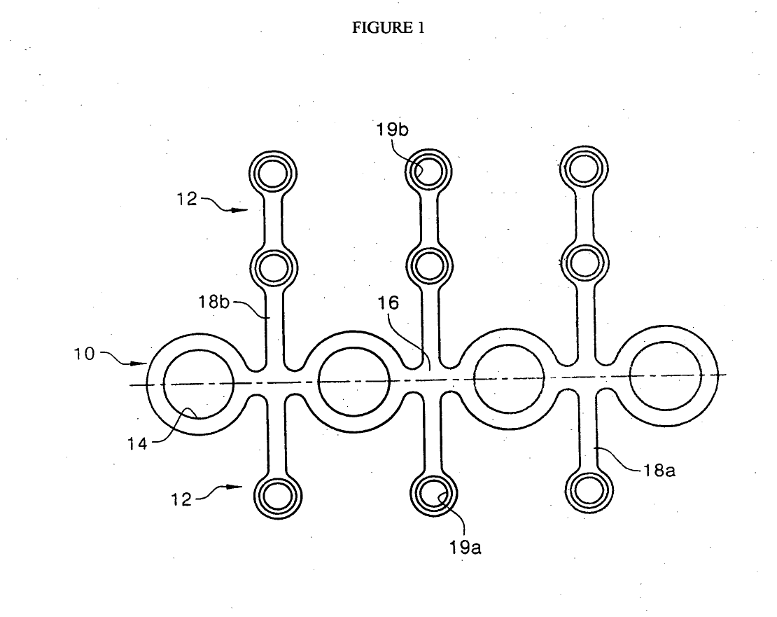

FIG. 1 is a detailed drawing of the first example plate of this invention. The first example plate includes the body section (10), and multiple arms (20) extending outward along the length of the body section (10). The body section is flat shaped and four pass-through holes (14) are formed along its length. The cross section of the pass-through (4) holes is circular and connecting sections (16) exist between the pass-through holes (14). Also, the pass-through holes (14) are designed to be independently aligned with the missing tooth during plate placement. Here out of the 4 pass-through holes (14) two pass-through holes (14) are for premolar and two pass-through holes are for molar.

The arm section (12) extends from sides of the connecting section between the pass-through holes (14) of the body section. The arm section comprises of three short arms (18a) which extend to palatal side during plate installation, and three longer arms (18b) which extend to the buccal side. The longer arms are formed with pass-through holes (19a) at the terminal allowing micro screws to pass through the holes, and the short arms (18b) are formed with pass-through holes (19b) at the terminal and center, each allowing a micro screw to pass through.

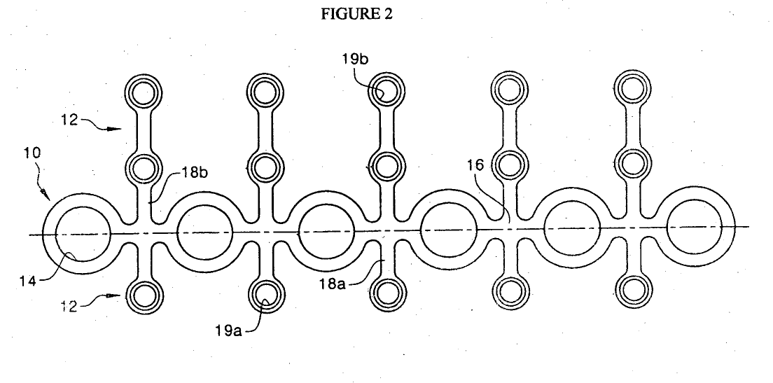

FIG. 2 is a detailed drawing of a different plate from the first example plate that has a different number of arms (12) extending from the body section (10). The body section (10) has 6 pass-through holes (14) with circular cross section shape, and connecting plates (16) between these pass-through holes (14).

The arm section (12) comprises of five short arms (18a) which extend to the palatal side and five longer arms (18b) which extend to the buccal side during plate installation. The longer arms have pass-through holes (19a) at the terminal allowing micro screws to pass through the holes and the short arms (18b) have pass-through holes (19b) at the terminal and center, each allowing micro screws to pass through the holes.

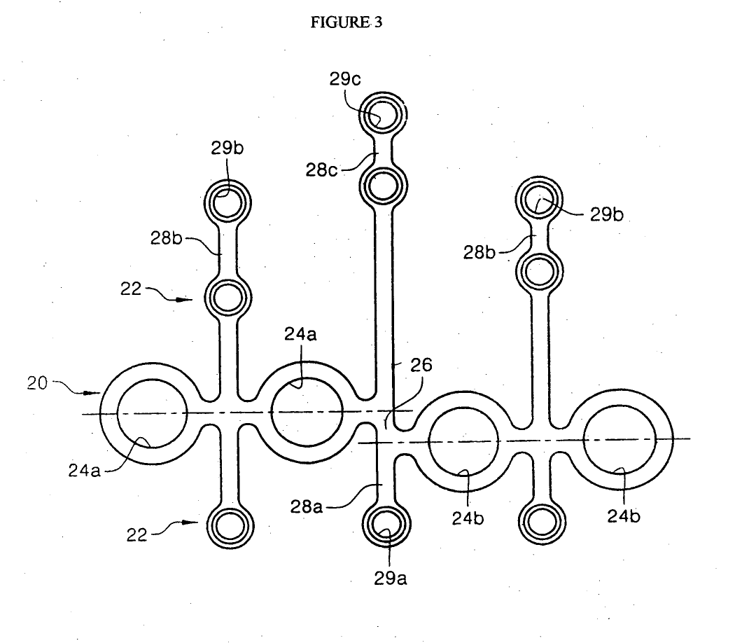

FIG. 3 is a detailed drawing of the second example plate of this invention. This example plate includes a body section (20) and multiple arms extending outward along the length of the body section (20). The body section is flat shaped and along its length 4 pass-through holes (24a, 24b) are formed in a row. The cross section of the pass-through (24a, 24b) is circular and there are connecting sections (26) between the pass-through holes (24a, 24b). Also, the pass-through holes (24a, 24b) are designed to be independently aligned with the missing tooth during plate placement. Out of the 4 pass-through holes (24a, 24b) two pass-through holes (24a) are for premolar and two pass-through holes (24b) are for molar. The pass-through holes (24a, 24b) for the premolar and molar are offset by 1 mm to 2 mm to coincide with the adult anatomical oral structure.

The arm section (22) extends outward from sides of the connecting section (26) between the pass-through holes (24a, 24b) of the body section. The arm section (22) comprises of three short arms (28a) which extend to palatal side during plate installation, and three longer arms (28b) which extend to the buccal side. The short arms (28a) have pass-through holes (29a) at the terminal allowing micro screws to pass through the holes and the long arms (28b, 28c) have pass-through holes (29b, 29c) at the terminal and center, each allowing micro screws to pass through the holes. The arm (28c) extending from the center of the longer arms (28b,28c) is longer than the arms (28b) extending from that side to enable the micro screws passing through the hole (29c) to be fixed to the zygomatic process area of the weakened maxilla.

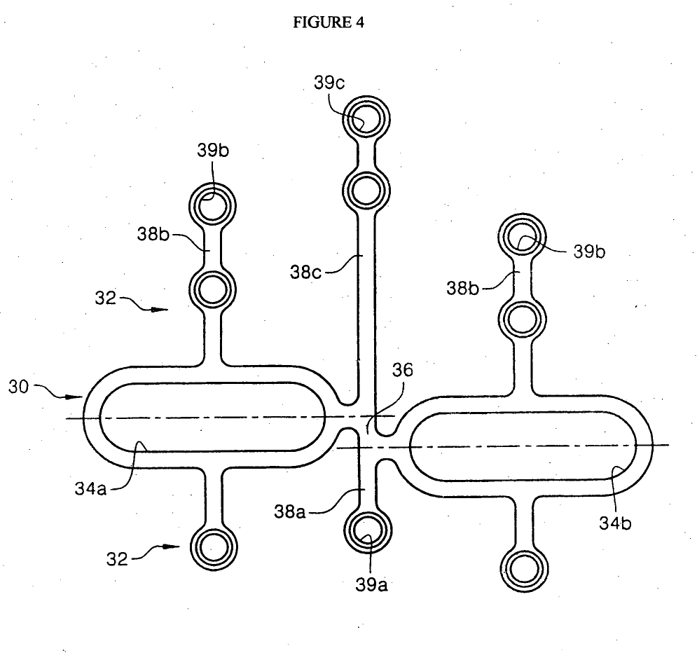

FIG. 4 is a detailed drawing of the third example plate of this invention. This example plate includes a body section (30) and multiple arms (32) extending outward along the length of the body (30) section. The body section is flat shaped and 2 pass-through holes (34a, 34b) are formed in a row along its length. The cross section of the pass-through holes (34a, 34b) is oval and the there are connecting sections (36) between the pass-through holes (34a, 34b). Also, the pass-through holes (34a, 34b) are designed to be independently aligned with the missing tooth during the plate placement. Here, the pass-through holes (34a, 34b) are offset to coincide with the premolar and molar area. The offset distance of the pass-through holes (34a, 34b) are 1 mm to 2 mm considering the adult anatomical oral structure.

The arms (32) extend outward from sides of the connecting section (36) between the pass-through holes (34a, 34b) of the body section. The arm section (32) comprises of three short arms (38a) which extend to palatal side during plate installation, and three longer arms (38b) which extend to the buccal side. The short arms (38a) connecting to the palatal side have pass-through holes (39a) at the terminal allowing micro screws to pass through the holes and the long arms (38b,38c) connecting to the buccal side have pass-through holes (39b, 39c) at the terminal and center, each allowing micro screws to pass through the holes. The center arm (38c) extending from the connecting section of the three longer arms (38b,38c) are longer than the arms (38b) extending from that side to enable the micro screws passing through the terminal hole (39c) to end in the zygomatic process area of the weak bone.

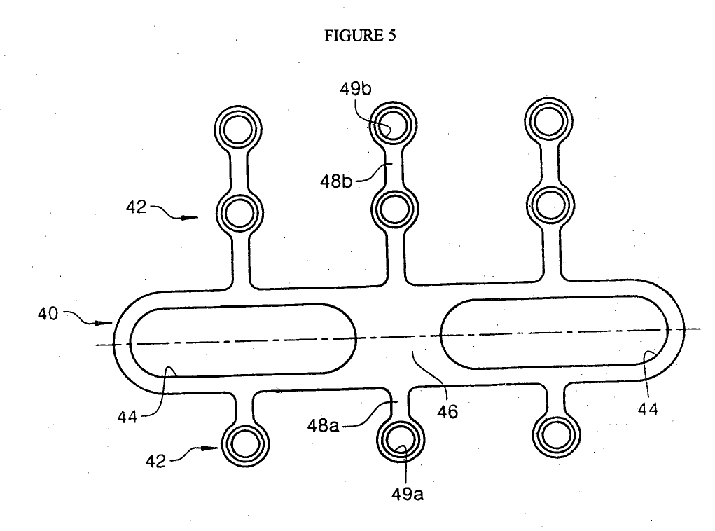

FIG. 5 is a detailed drawing of the 4th example plate of this invention. This example plate includes the body section (40) and multiple long arms (42) extending from one side of the body (40). The body section is flat shaped and along its length 2 pass through holes (44) are formed in a row. The cross section of the body's pass-through holes (44) is oval. The pass-through holes (44) are designed to be independently aligned with the missing tooth during plate placement.

The arms (42) are extended outward from sides of the connecting section (46) between the pass-through holes (44) of the body section. The arm section (42) comprises of three short arms (48a) which extend to palatal side during plate installation, and three longer arms (48b) which extend to the buccal side. The short arms (48a) have pass-through holes (49a) at the terminal allowing micro screws to pass through the holes and the long arms (48b) have pass-through holes (49b) at the terminal and center, each allowing micro screws to pass through the holes.

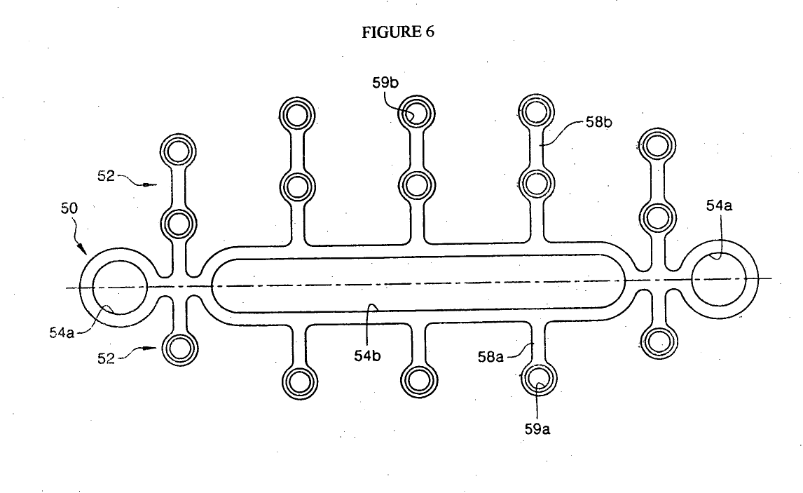

FIG. 6 is a detailed drawing of the fifth example plate of this invention. This example plate includes the body section (50) and multiple long arms (52) extending from one side of the body (50). The body section is flat shaped and there are pass-through holes (54a, 54b) along its length. The pass-through (54a, 54b) holes consist of one oval shaped pass-through hole (54a) placed in the center and circular pass-through holes (54b) located on each end. The pass-through holes (54a, 54b) are also designed to be independently aligned with the missing tooth during plate placement.

The arms (52) are extended outward from each sides of the connecting section (56) between the pass-through holes (54a, 54b) of the body section. The arm section (52) comprises of five short arms (58a) which extend to palatal side during plate installation, and three longer arms (58b) which extend to the buccal side. The short arms (58a) connecting to the palatal side have pass-through holes (59a) at the terminal allowing micro screws to pass through the holes and the long arms (58b) connecting to the buccal side have pass-through holes (59b) at the terminal and center, each allowing micro screws to pass through the holes.

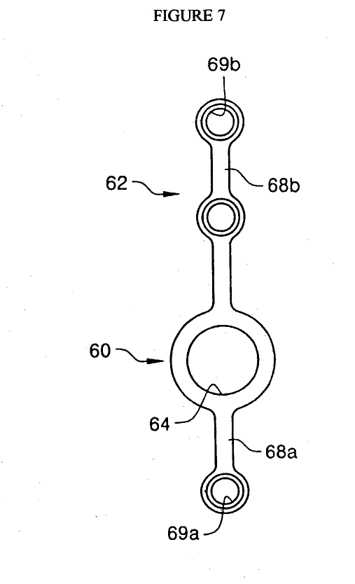

FIG. 7 is a detailed drawing of the 6th example plate of this invention. This example plate includes a body section (60) with a pass-through hole and arms (62) extending outward from each side of the body (60). The body section (70) is flat shape and there is a circular pass-through hole (64) in its center.

The arms (62) are extended in the opposite direction from each other and consist of a shorter arm (68a) which extends to the palatal side during plate installation, and a longer arm (68b) which extends to the buccal side. The short arm (68a) connecting to the palatal has a pass-through hole (69a) at the terminal allowing a micro screw to pass through the hole and the long arm (68b) connecting to the buccal side has pass-through holes (69b) at the terminal and center, each allowing micro screws to pass through the holes.

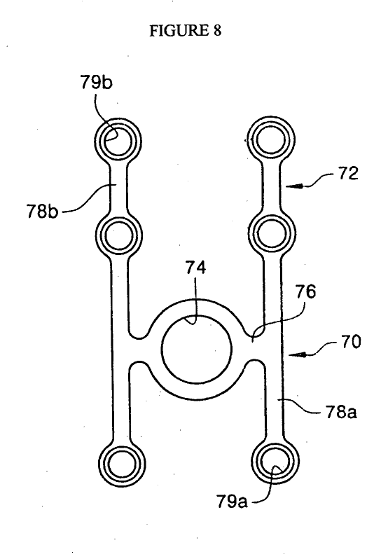

FIG. 8 is a detailed drawing of the 7th example plate of this invention. This example plate includes a body section (70) with a pass-through hole and arms (72) extending from each side of the body (70). The body section (70) is flat shape and there is a pass-through hole (74) in its center. There are projections 72) on each side of the body's pass-through hole.

The arms (62) are extended from the end of the projections from each side of the body (70) in the opposite direction from each other. The shorter arms (78a) extend to palatal side during plate installation, and longer arms (78b) extend to the buccal side. The short arms (78a) connecting to the palatal side have a pass-through hole (79a) at the terminal allowing micro screws to pass through the holes and the long arms (68b) connecting to the buccal side have pass-through holes (69b) at the terminal and center, each allowing micro screws to pass through the holes.

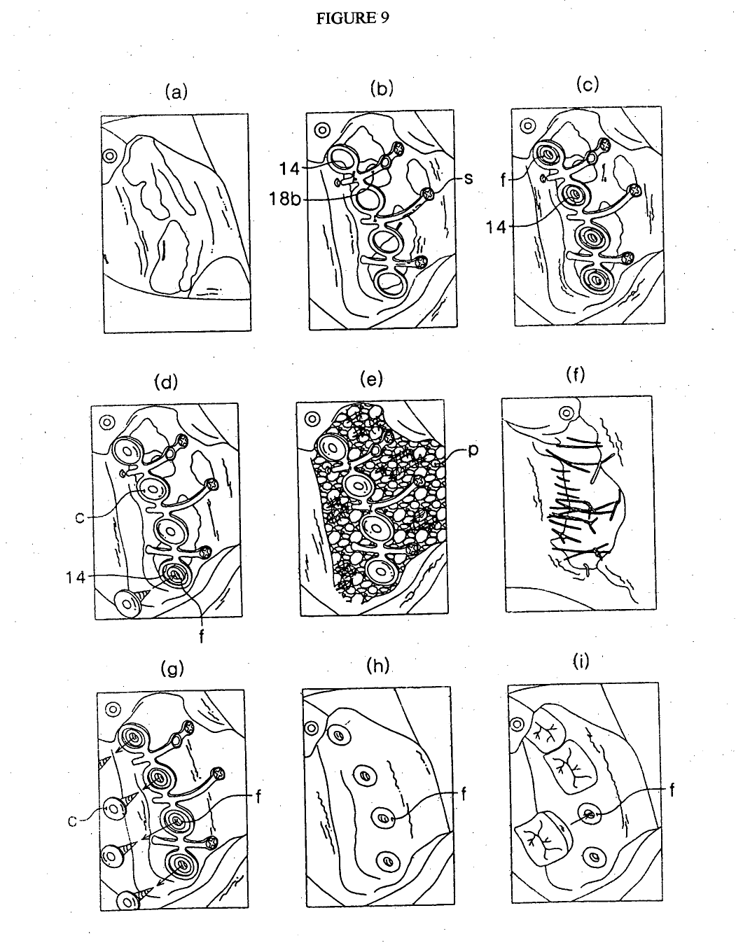

Following is a detailed description of the usage of the plate in this invention in reference to the included figure. FIGS. 9a through 9i show the step by step installation of the plate in this invention.

FIG. 9a shows the incision in the membrane of the seriously damaged alveolar ridge or crest area and one can see the damaged condition of the alveolar ridge bone. With the plate from this invention, it is possible to install the implant to the damaged alveolar ridge bone like the one shown in 9a.

First, an incision is made in the oral membrane in the problem area exposing the bone in the area where regeneration and implant placement is needed. When the bone is exposed, the plate is placed above the weak alveolar ridge area, and as shown in FIG. 9b, the micro screws are inserted through the small holes in the arms (18b) of the plate to connect to the alveolar ridge bone to fix the plate.

Next, the implant fixture (f) is placed on the weak bone by passing it through the pass-through holes (14) of the body section of the plate as shown in FIG. 9c. Then, as shown in FIG. 9d, the cover screws (c) pass through the pass-through holes of the plate's body section and are screwed onto the implant fixture (f). Here, the head section of the cover screws (c) adheres to the body section (10) of the plate in order to firmly secure the implant fixture (f) and the plate to each other.

Next comes suturing the cut oral membrane as shown in FIG. 9f. In the case where the bone is damaged or lacking around the poor area, the bone regeneration procedure to recover the alveolar bone by transplanting the block bone (p) to the poor area is performed prior to suturing as shown in FIG. 9e.

Next, when bone integration between the implant fixture (f) and the alveolar bone is accomplished after some time, the oral membrane is once again cut and the cover screws (c) in the implant fixture (f) are removed as shown in FIG. 9g. Removing the cover screws (c) this way leaves the plate and the implant fixture in a simply attached state. The micro screws attached to the plate arms can then be removed and the plate can be taken out of the mouth FIG. 9h, which is a drawing of the state after plate removal, shows the view of the implant fixture (f) after the plate removal.

Finally, as shown in FIG. 9i, supplemental materials are installed on the implant fixture (f).

As demonstrated above, the plate in this invention is fixed to the weak bone using micro screws and attaches to the implant fixture through cover screws, prohibiting implant fixture movement and resulting in good bone integration between the implant fixture and alveolar ridge bone. Such plate also prevents infections inside the oral membrane after the implant installation because once bone integration between the implant fixture and alveolar ridge bone is completed, supplementary material can be installed after unscrewing and removing the micro screws in the arms' pass-through holes and the cover screws in the body's pass-through holes out of the mouth. Also, the plate can be used to pre-fix the implant fixture to alveolar ridge bone under seriously damaged state, thereby allowing simultaneously the implant fixture installation and bone regeneration operation. The result is an epochal reduction in total treatment time for a patient with damaged alveolar ridge bone. This plate also provides bone regeneration space for bones with serious resorption problem and once bone amount is increased and the implant and the bone have been integrated the plate can be readily removed. Because the plate in this invention is designed to be removed once the implant is firmly fixed to the bone after the bone increase, it will not cause any infection due to rubbing, unwanted exposure within the mouth, or foreign sensation.

In addition, not only is it possible for the augmentation plate in this invention to be fixed on to alveolar bone, but it can also be fixed to the weak bones. The augmentation plate allows safe installation on a correct location by allowing the implant to be installed through the pre-arranged pass-through holes of the body section, and at the same time, using the long oval shaped plates, the relative distance between the implants can also be adjusted.

1. Augmentation plates for stabilizing dental implant fixtures and bone regeneration which is characterized by; a thin plane shape, a body section comprised of one or more holes formed in a row, multiple arms extending from the body section with hole(s) in each arm's terminal for micro screws to fix onto the alveolar ridge bone or facial bone, and hole(s) in the body section, located between the implant fixture(s) and the cover screw(s), stabilizing the implant fixture(s).

2. The plate according to claim 1, wherein said the body section is comprised of one or more holes formed in a row, wherein at least one of the multiple holes of the body is long oval shape.

3. The plate according to claim 1 or claim 2, wherein at least one hole of the body's holes is placed with an offset by a set distance within the plane of the plate.

4. The plate according to claim 3, wherein the above mentioned offset hole in the body section has an offset distance of less than or equal to 2 mm.

5. The plate according to claim 1 or claim 2, wherein the arms extending from one side of the body section are longer than the arms extending from the opposite side of the body section.

6. The plate according to claim 5, wherein the center arm extending from one side of the body section is longer than the other arms extending from the same side allowing micro screws to be placed in the zygomatic process area of the weak bone.
